(19) United States
(12) Patent Application Publication
(10) Pub. No.: US 2006/0082187 A1
(43) Pub. Date: Apr. 20, 2006

(54) Snap pin for door module positioning

(75) Inventors: Everardo A. Hernandez, Shelby Township, MI (US); Santhosh Kumar Karumuri, Inkster, MI (US)

Correspondence Address: CARLSON, GASKEY & OLDS, P.C., 400 WEST MAPLE ROAD, SUITE 350, BIRMINGHAM, MI, 48009, US

(73) Assignee: Arvinmeritor Technology, LLC

(21) Appl. No.: 10/967,968

(22) Filed: Oct. 19, 2004

(51) Int. Cl. B60J 5/00

(52) U.S. Cl. 296/146.1

(57) ABSTRACT

A door module assembly includes a door module panel having a plurality of locating pins. An inner door panel includes a plurality of openings that cooperate with the plurality of locating pins to align the door module panel relative to the inner door panel and to retain the door module panel on the inner door panel without requiring fasteners. Each locating pin includes a central body portion with first and second pin ends. The first pin end is snapped into an opening formed in the door module panel. The first pin end includes a plurality of resilient legs that provide positive location and positive retention during assembly of the locating pin onto the door module panel. The second pin end includes an undercut retention groove that provides a positive stop to prevent separation between the inner door panel and the door module panel.

### TECHNICAL FIELD

The subject invention relates to a door module positioning system with a plastic pin that is snapped into a door module panel for supporting and retaining the door module panel on an inner door panel.

### BACKGROUND OF THE INVENTION

Door module assemblies include a door module panel that supports components such as door locks and window lifters, for example. The door module panel is attached to an inner door panel on a vehicle door. Typically, a door module assembly includes locating pins that extend outwardly from one side of the door module panel. The locating pins are separate components that are mounted to the door module panel and then inserted into openings formed in the inner door panel to align the door module panel relative to the inner door panel.

The locating pins are formed from a metal material and are inserted through an opening in the door module panel with one pin end subsequently being deformed against the door module panel to secure the locating pin to the door module panel. The current method use to deform the pin end requires the use of an assembly fixture and a spin rivet machine. This method is time consuming and expensive.

Another disadvantage with the current locating pins is an inability to hold the door module panel in place on the inner door panel without the aid of mounting fasteners or other non-integrated mechanisms. Traditionally, each locating pin is perpendicular to the door module panel. Corresponding openings extend perpendicularly into one side of the inner door panel. One disadvantage with this configuration is that the door module panel must be immediately fastened to the inner door panel to retain the door module panel to the inner door panel. Thus, the locating pins alone cannot be used to hold the door module panel to the inner door panel.

This perpendicular orientation of the locating pins could result in the door module panel sliding away and separating from the inner door panel if the door module panel and inner door panel are not immediately fastened together after alignment. This means that the alignment and attachment steps must be performed at the same assembly line station. This makes assembly more difficult and expensive.

Thus, there is a need for a simplified and less expensive method for mounting locating pins to a door module panel. Further, the locating pins should be capable of both locating and holding the door module panel and inner door panel together without requiring the use of other fasteners, in addition to overcoming the other above-mentioned deficiencies in the prior art.

### SUMMARY OF THE INVENTION

A locating pin for a door assembly includes a central body portion and first and second pin ends. The first pin end is snapped into a first door panel and a second pin end is insertable into a second door panel. The locating pin holds and retains the first and second door panels together so that additional assembly steps can be performed.

In one example, the first pin end is snapped into a door module panel that supports at least one door module component, such as a window lifter or door lock mechanism for example. The second pin end is inserted into an inner door panel, which is part of the door assembly. The first pin end includes a resilient retention feature comprising a plurality of legs that is pushed through an opening in the door module panel and snapped into place. The plurality of legs includes a first set of legs that serve to align and locate the locating pin relative to the opening in the door module panel and a second set of legs that serve to retain the locating pin on the door module panel.

In one disclosed embodiment, each leg in the first set of legs includes a tapered body portion to facilitate alignment and insertion. Each leg in the second set of legs moves inwardly from an initial position during insertion and is resiliently biased to return to the initial position after insertion. When the second set of legs is in the initial position after insertion, each leg provides a stop that prevents the locating pin from being removed from the door module panel.

The second pin end includes a retention feature that prevents the door module panel from separating from the inner door panel after a locating pin has been inserted into the inner door panel. In one example, the retention feature comprises an undercut groove that surrounds at least a portion of an outer perimeter of the second pin end. If one of the door module panel or inner door panel slips, a stop ledge formed as part of the undercut groove abuts against the inner door panel to prevent separation.

The locating pin also includes a washer portion that enhances stability after the locating pin is inserted into the inner door panel. The washer portion is formed on the central body portion between the first and second pin ends. After insertion, the washer portion is located between the inner door panel and the door module panel.

Preferably, the locating pin is formed from a molded plastic material. The central body portion, first and second sets of legs, and washer portion are all preferably integrally formed as a single piece.

Utilization of a plastic locating pin that is snapped into a door module panel eliminates the need for a spin rivet machine and associated assembly steps. Additionally, the subject locating pin includes retention features at both pin ends to prevent pin separation from the door module panel and the inner door panel without requiring any additional fastening elements. These and other features of the present invention can be best understood from the following specification and drawings, the following of which is a brief description.

### BRIEF DESCRIPTION OF THE DRAWINGS

FIG. 1 is a schematic side view of a door module assembly incorporating the subject invention.

FIG. 2 is a perspective view of a locating pin incorporating the subject invention.

FIG. 3 is a perspective assembled view of one end of the locating pin of FIG. 2 as installed within a door module panel.

FIG. 4 is a perspective assembled view of an opposite end of the locating pin and door module panel of FIG. 3.

FIG. 5 is a cross-sectional view of the locating pin of FIG. 2 securing a door module panel to an inner door panel.

FIG. 6 is a cross-sectional view taken along lines 6-6 of FIG. 4.

FIG. 7 is a view similar to that of FIG. 6 but showing the inner door panel in a slip but retained position.

### DETAILED DESCRIPTION OF THE PREFERRED EMBODIMENT

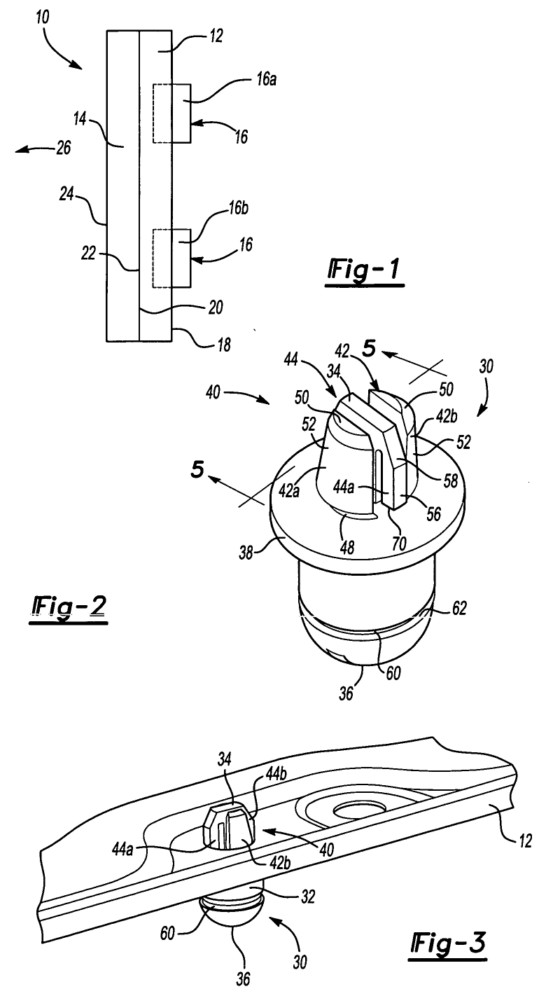

A door module assembly 10 is shown schematically in FIG. 1. The door module assembly 10 includes a door module panel 12 and an inner door panel 14. Door module components 16 are mounted to the door module panel 12. The door module components 16 can be any type of known door module component such as a window lifter mechanism 16a or a door lock mechanism 16b, for example.

The door module panel 12 includes an outer surface 18 and an inner surface 20 that faces the inner door panel 14. The inner door panel 14 includes an outer surface 22 that faces the door module panel 12 and an inner surface 24 that faces towards a passenger compartment. Location of the passenger compartment is generally indicated by arrow 26.

At least one locating pin 30, shown in FIG. 2, extends outwardly from one of the door module panel 12 or inner door panel 14 towards the other of the door module panel 12 or inner door panel 14. The locating pin 30 is used to mount and hold the door module panel 12 and inner door panel 14 together so that additional door assembly steps can be completed. It should be understood that while only one locating pin 30 is shown in the figures, typically at least two or more locating pins 30 are used.

As shown in FIG. 3, each locating pin 30 includes a central body portion 32 with a first pin end 34 and a second pin end 36. A washer portion 38 is formed about a perimeter of the central body portion 32 between the first 34 and second 36 pin ends. In the example shown, the washer portion 38 has a greater diameter than both the first 34 and second 36 pin ends to enhance stability after the door module panel 12 has been attached to the inner door panel 14.

The first pin end 34 includes a retention feature that allows the locating pin 30 to be snapped into an opening on one of the inner door panel 14 or door module panel 12. The retention feature comprises a plurality of legs, shown generally at 40, that both positively locate and positively retain the locating pin 30 in place. The plurality of legs 40 includes a first set of legs 42 and a second set of legs 44. The first set of legs 42 is formed to align and facilitate insertion while the second set of legs 44 is formed to retain the locating pin 30 in place.

Each leg 42 in the first set of legs 42 includes neck portion 46 (see FIG. 5) that expands out to a base portion 48. The base portion 48 extends to a distal tip 50. In order to provide the locating and aligning feature, a tapered surface 52 extends between the base portion 48 and the distal tip 50. The base portion 48 is of a greater thickness than the distal tip 50. Also, each leg 42 in the first set of legs 42 is cantilevered with the neck portion 46 being formed or fixed with the central body portion 32, and the distal tips 50 being unsupported or moveable relative to the central body portion 32.

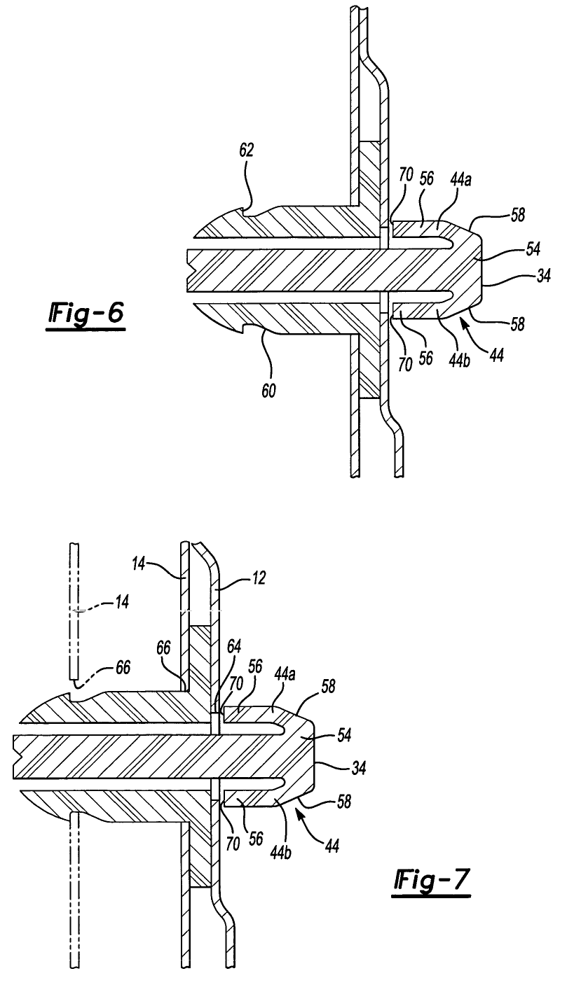

Each leg 44 in the second set of legs 44 (see FIGS. 6 and 7) includes a base portion 54 that extends to a distal tip 56. The base portion 54 is formed immediately at an end of the first pin end 34. The base portion 54 transitions into an angled portion 58, which transitions into a generally straight portion that extends to the distal tip 56. Each leg 44 in the second set of legs is resiliently biased such that each leg 44 moves from an initial position inwardly toward the central body portion 32 during insertion and automatically returns to the initial position after insertion. After installation, the distal tips 56 serve as stops to prevent the location pin 30 from being removed. This will be discussed in greater detail below.

Also, each leg 44 in the second set of legs 44 is cantilevered with the base portion 48 being formed or fixed with the central body portion 32, and the distal tips 56 being unsupported or moveable relative to the central body portion 32. As shown, the distal tips 56 of the second set of legs 44 and the distal tips 50 of the first set of legs 42 extend in opposing directions. The distal tips 56 of the second set of legs 44 extend in a direction generally toward the central body portion 32 and the distal tips 50 of the first set of legs 42 extend in a direction way from the central body portion 32.

This configuration provides a dual functional snap retention feature. The distal tips 50 of the first set of legs 42 extend away from the central body portion 32 to provide the aligning and location feature. The second set of legs 44 extend toward the central body portion 32 to provide the retaining feature.

The second pin end 36 also includes a retention feature. In the example shown in FIG. 2, the retention feature comprises a groove 60 that is formed about a perimeter of the second pin end 36. The groove 60 is preferably formed as an undercut and can extend continuously or discontinuously about the perimeter of the second pin end 36. The undercut extends into the central body portion 32 to form a stop surface 62 that prevents the door module panel 12 and the inner door panel 14 from separating. This will be discussed in greater detail below.

In order to reduce cost, the locating pin 30 is preferably formed from a plastic material. Any type of plastic material known in the art could be used. The plastic material should be strong enough to withhold initial loads seen at the time of installation into the door module panel 12. The plastic material can be molded in to a final shape by any known molding process. Preferably, the central body portion 32, the first 42 and second 44 sets of legs, and the washer portion 38 are all integrally molded from plastic as a single piece.

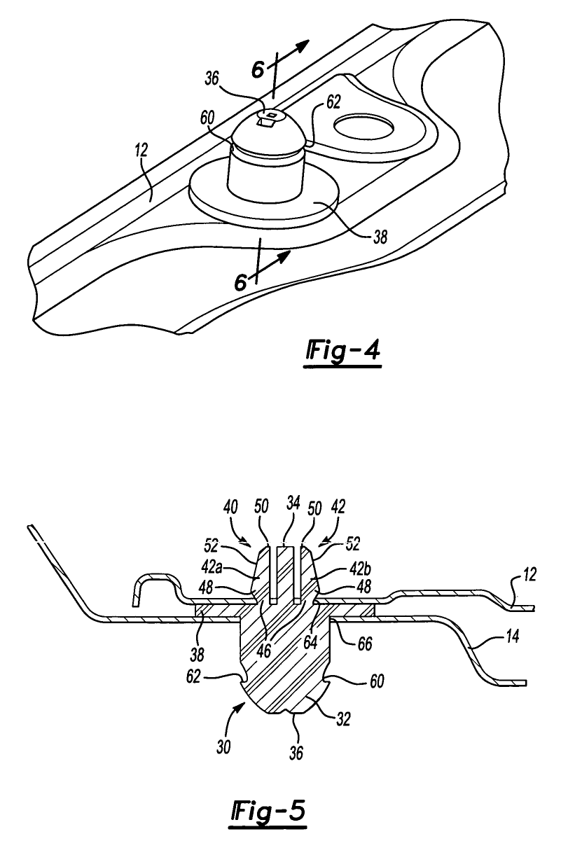

In an example shown in FIGS. 3 and 4, the locating pin 30 is inserted into an opening 64 formed in the door module panel 12. FIG. 3 shows a view with the first 42 and second 44 sets of legs extending outwardly from the outer surface 18 of the door module panel 12. FIG. 4 shows a view with the second pin end 36 extending outwardly from the inner surface 20 of the door module panel. In this figure, the washer portion 38 is shown as directly abutting against the inner surface 20.

The first set of legs 42 are shown in an installation position in FIG. 5. During insertion, the distal tips 50 of the first set of legs 42 are inserted through opening 64 in the door module panel 12, and the first set of legs 42 slides along the tapered surface 52 until the neck portion 46 is received within the opening 64. The second pin end 36 is inserted through an opening 66 formed within the inner door panel 14. The central body portion 32, near the washer portion 38, is surrounded by the opening 66 in the installation position.

The second set of legs 44 are shown in an installation position in FIG. 6. During insertion, the distal tips 56 are moved inwardly from the initial position to a compressed position. After insertion the distal tips 56 are resiliently biased to return to the initial position. In the initial position, the distal tips 56 provide stop surfaces 70 to prevent the locating pin 30 from being removed from the door module panel 12. The washer portion 38 is in direct abutting engagement with the door module panel 12 and the inner door panel 14 and enhances stability to keep the locating pin 30 from rocking or tipping.

FIG. 7 shows the retention feature of the second pin end 36. If the inner door panel 14 and the door module panel 12 start to slip or slide relative to one another, the stop surface 62 of groove 60 engages the inner surface 24 of the inner door panel 14 (shown in a slip position in dashed lines) to prevent separation between the inner door panel 14 and the door module panel 12. Thus, the locating pins 30 can retain and hold the door module panel 12 to the inner door panel 14 without requiring any additional mounting hardware. This allows subsequent assembly steps to take place prior to a step of permanently fastening the door module panel 12 and the inner door panel 14 together.

The subject invention provides a reduced weight, plastic snap-in locating pin that combines positive location and positive retention without requiring additional mounting structures. Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A door module assembly comprising:
a door module panel mountable to an inner door panel; and
at least one locating pin having a first pin end and a second pin end wherein said first pin end includes a resilient retention feature that is snapped within one of said door module panel and the inner door panel to fix said at least one locating pin to said one of said door module panel and the inner door panel and wherein said second pin end is receivable by the other of said door module panel and the inner door panel for holding said door module panel and the inner door panel together.

2. The door module assembly according to claim 1 wherein said resilient retention feature is snapped into said door module panel.

3. The door module assembly according to claim 2 wherein said resilient retention feature includes a plurality of legs.

4. The door module assembly according to claim 3 wherein said plurality of resilient legs includes a first set of legs for locating said at least one locating pin in said door module panel and a second set of legs for retaining said at least one locating pin in said door module panel.

5. The door module assembly according to claim 4 wherein each leg in said first set of legs includes a base portion extending to a distal tip wherein said base portion is thicker than said distal tip of said first set of legs.

6. The door module assembly according to claim 4 wherein each leg in said second set of legs includes a base portion extending to a distal tip wherein each of said distal tips of said second set of legs moves inwardly from an initial position toward a pin center during insertion of said at least one locating pin into said door module panel and wherein each of said distal tips of said second set of legs is resilient biased to return to said initial position after said at least one locating pin is mounted to said door module panel.

7. The door module assembly according to claim 4 wherein each leg is said first set of legs includes a first base portion extending to a first cantilevered tip and each leg in said second set of legs includes a second base portion extending to a second cantilevered tip, said first cantilevered tip being positioned immediately adjacent to said second base portion and said second cantilevered tip being positioned immediately adjacent to said first base portion.

8. The door module assembly according to claim 2 wherein said second pin end includes a retaining portion for preventing said door module panel from separating from the inner door panel.

9. The door module assembly according to claim 8 wherein said retaining portion comprises an undercut groove formed at least partially about a perimeter of said second pin end.

10. The door module assembly according to claim 2 wherein said at least one locating pin includes a washer portion positioned between said first and second pin ends and received between said door module panel and the inner door panel, said washer portion having a greater diameter than both said first and second pin ends.

11. A locating pin for a door module assembly comprising:
a central body portion having a first pin end and a second pin end;
a resilient retention feature formed on said first pin end, said resilient retention feature adaptable for a snap fit into a door module panel; and
a retaining portion formed on said second pin end, said retaining portion adaptable for preventing separation between the door module panel and an inner door panel.

12. The locating pin according to claim 11 wherein said resilient retention feature comprises a plurality of legs including a first set of legs for locating the first pin end relative to the door module panel and a second set of legs for retaining the first pin end to the door module panel.

13. The locating pin according to claim 12 wherein each leg of said first set of legs includes a tapered surface.

14. The locating pin according to claim 12 wherein each leg of said first set of legs includes a fixed leg end and a movable leg end and wherein each leg of said second set of legs includes a fixed leg end and a moveable leg end and wherein said movable leg ends of said first set of legs extend away from said central body portion and said movable leg ends of said second set of legs extend toward said central body portion.

15. The locating pin according to claim 12 wherein said retaining portion comprises a stop surface for engaging a surface of an inner door panel.

16. The locating pin according to claim 15 wherein said stop surface is formed as part of a groove that surrounds at least a portion of a perimeter of said second pin end.

17. The locating pin according to claim 11 including a washer formed around said central body portion between said first and second ends.

18. The locating pin according to claim 17 wherein said central body portion, said resilient retention feature, said retaining portion, and said washer are all integrally formed together as one piece from a plastic material.

19. A method of attaching a locating pin to a door module panel comprising:
(a) providing a locating pin having a central body portion with first and second pin ends;
(b) snapping the first pin end into an opening formed in a door module panel to fix the locating pin to the door module panel; and
(c) positioning the second pin end for receipt within an opening formed in an inner door panel.

20. The method of claim 19 including forming a retention feature on the first pin end comprising a plurality of legs, moving the plurality of legs inwardly during insertion of the first pin end into the opening formed in the door module panel, resiliently biasing the plurality of legs to automatically move outwardly after insertion of the first pin end into the opening formed in the door module panel, and forming a retaining groove about a perimeter of the second pin end to prevent separation of the inner door panel from the door module panel after the second pin end has been inserted into the opening formed in the inner door panel.
